(19) United States
(12) Patent Application Publication
(10) Pub. No.: US 2025/0287104 A1
(43) Pub. Date: Sep. 11, 2025

(54) IMAGING APPARATUS, METHOD FOR CONTROLLING THE SAME, AND STORAGE MEDIUM

(71) Applicant: CANON KABUSHIKI KAISHA, Tokyo (JP)

(72) Inventor: TAKAHARU OSAWA, Kanagawa (JP)

(21) Appl. No.: 19/069,032

(22) Filed: Mar. 3, 2025

(30) Foreign Application Priority Data
Mar. 5, 2024 (JP) 2024-033389

(51) Int. Cl. H04N 23/695; H04N 23/661

(52) U.S. Cl. CPC H04N 23/695; H04N 23/661

(57) ABSTRACT

A control apparatus controls an imaging apparatus including a drive unit for changing an imaging direction, and includes a calculation unit configured to calculate a target speed set to drive the drive unit at a predetermined speed and an acceleration of the driving speed of the drive unit, a control unit configured to control the drive unit based on the calculated target speed and the calculated acceleration, and a determination unit configured to determine whether a time period during which the drive unit accelerates within a range of a stipulated speed is longer than a preset stipulated time period being defined based on a structural resonance of the imaging apparatus, wherein, in a case where the determination unit determines that the time period is longer than the stipulated time period, the calculation unit calculates the acceleration so that the time period does not exceed the stipulated time period.

### BACKGROUND

### Field of the Disclosure

The present disclosure relates to a technique for controlling a camera including controllable pan and tilt drive units.

### Description of the Related Art

In recent years, there have been increasing needs for remotely controlling pan and tilt drive units of a camera drivable in the pan and tilt directions on video production sites (hereinafter such control is referred to as PT control, and such a camera is referred to as a PT camera).

When such a PT camera is driven at a speed in a stipulated range, the mechanical characteristics of the pan and tilt drive units may cause a resonance vibration (hereinafter a speed at which a resonance vibration occurs is referred to as a resonance speed, and a predetermined speed range is referred to as a resonance range). Meanwhile, because the quietness and smooth PT control are required for remote cameras used for video production, there has been a demand for a technique for preventing a resonance vibration. For example, Japanese Patent Application Laid-Open No. 2022-101206 discloses a method for determining whether the driving speed of each of pan and tilt drive units is included in a stipulated speed range (resonance range)) and changing the driving speed.

However, the prior art disclosed in Japanese Patent Application Laid-Open No. 2022-101206 does not take into consideration a resonance vibration in a case where the driving speed of each of the pan and tilt drive units in a certain time period becomes the resonance speed during the acceleration or deceleration of the driving speed. With a camera used for video production requiring the quietness and smooth PT control when it starts and stops moving, desirably, a resonance vibration can be reduced during the acceleration or deceleration.

### SUMMARY

The present disclosure is directed to a technique for reducing a resonance occurring when changing the driving speed of a drive unit of an imaging apparatus.

According to an aspect of the present disclosure, a control apparatus is configured to control an imaging apparatus including a drive unit for changing an imaging direction, and the control apparatus includes a calculation unit configured to calculate a target speed set to drive the drive unit at a predetermined speed and an acceleration of the driving speed of the drive unit, a control unit configured to control the drive unit based on the target speed and the acceleration calculated by the calculation unit, and a determination unit configured to determine whether a time period during which the drive unit driven at the driving speed accelerates within a range of a stipulated speed is longer than a preset stipulated time period, the stipulated speed being defined based on a structural resonance of the imaging apparatus, wherein, in a case where the determination unit determines that the time period during which the drive unit driven at the driving speed accelerates within the range of the stipulated speed is longer than the stipulated time period, the calculation unit calculates the acceleration so that the time period during which the drive unit accelerates does not exceed the stipulated time period within the range of the stipulated speed.

Further features of the present disclosure will become apparent from the following description of exemplary embodiments with reference to the attached drawings.

### BRIEF DESCRIPTION OF THE DRAWINGS

FIG. 1 illustrates a configuration of a system according to one or more aspects of the present disclosure.

FIG. 2 is a block diagram according to one or more aspects of the present disclosure.

FIG. 3A is a flowchart illustrating acceleration calculation processing for a pan drive unit of an imaging apparatus, and FIG. 3B is a flowchart illustrating speed control processing for the pan drive unit.

FIG. 4A illustrates a relation between a control time period and a stipulated speed range (resonance range) in controlling the drive units of the imaging apparatus according to one or more aspects of the present disclosure, and FIG. 4B illustrates a relation between the control time period and the stipulated speed range (resonance range) to make a time period of the acceleration equal to or shorter than a stipulated time period in controlling the drive units of the imaging apparatus according to one or more aspects of the present disclosure.

FIG. 5 is a flowchart illustrating acceleration calculation processing in controlling the drive units of the imaging apparatus according to one or more aspects of the present disclosure.

FIG. 6 is a flowchart illustrating acceleration calculation processing in controlling the drive units of an imaging apparatus according to one or more aspects of the present disclosure.

FIG. 7 illustrates a relation between the control time period and the stipulated speed range (resonance range) when the drive units of the imaging apparatus start moving according to one or more aspects of the present disclosure.

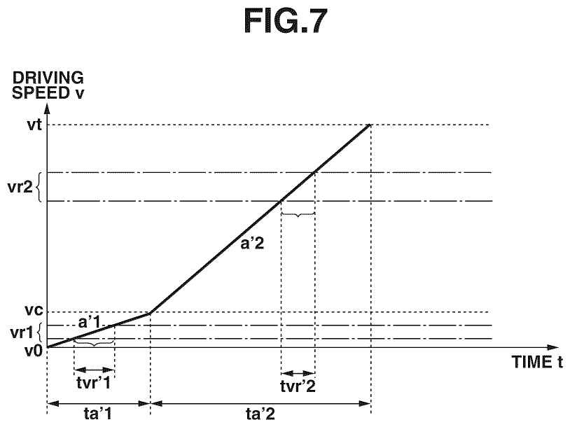

FIG. 8 is a flowchart illustrating acceleration calculation processing in controlling the drive units of an imaging apparatus according to one or more aspects of the present disclosure.

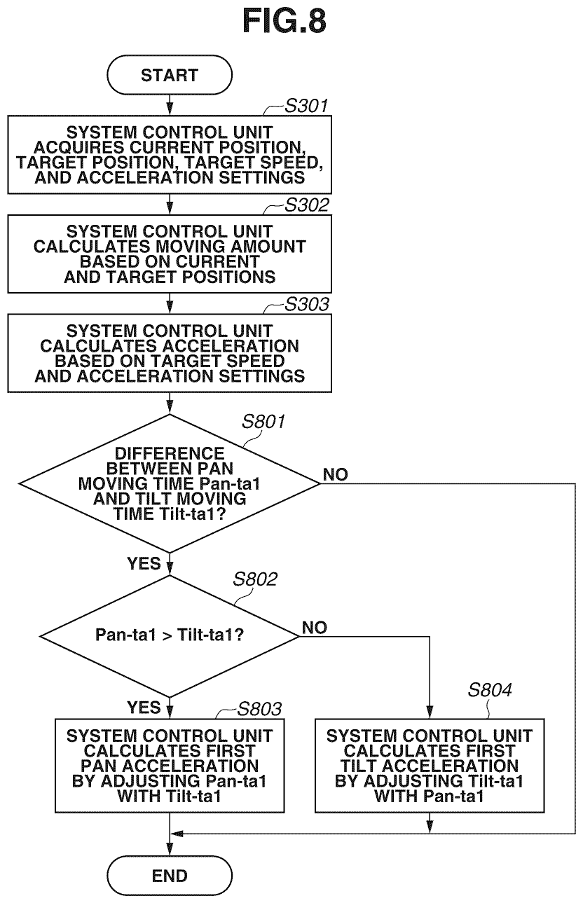

### DESCRIPTION OF THE EMBODIMENTS

Exemplary embodiments of the present disclosure will be described below with reference to the accompanying drawings. The following exemplary embodiments do not limit the present disclosure within the scope of the appended claims. Although a plurality of features is described in the exemplary embodiments, not all of the plurality of features is indispensable to the present disclosure, and the plurality of features may be arbitrarily combined. In the accompanying drawings, identical or similar components are assigned the same reference numerals, and duplicated descriptions thereof will be omitted.

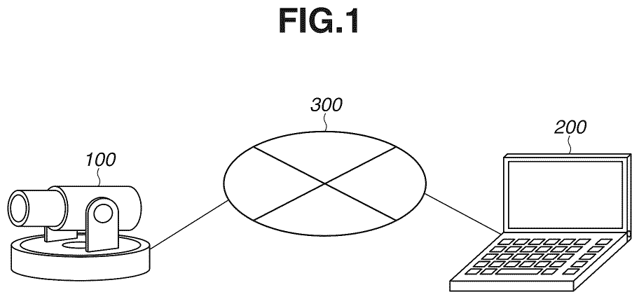

A first exemplary embodiment will be described below. FIG. 1 illustrates an imaging system according to the first exemplary embodiment. The imaging system according to the present exemplary embodiment includes an imaging apparatus 100, an external apparatus 200, and a network 300. The method for connecting these apparatuses is not limited to a particular method. For example, these apparatuses may be connected with cables. The imaging apparatus 100 receives a command from the external apparatus 200 via the network 300 and transmits a response from a system control unit 103 (described below) to the external apparatus 200 via the network 300. The imaging apparatus 100 includes a pan drive unit 106 and a tilt drive unit 108 (described below) and drives the pan drive unit 106 and the tilt drive unit 108 to change the imaging direction. The imaging apparatus 100 according to the present exemplary embodiment can drive the pan drive unit 106 and the tilt drive unit 108 to target speeds and positions set by the external apparatus 200. The pan drive unit 106 and the tilt drive unit 108 are accelerated (decelerated) with the accelerations calculated by the system control unit 103 until their driving speeds reach the target speeds. According to the present exemplary embodiment, the system control unit 103 calculates the acceleration so that the time period until the driving speed of the pan drive unit 106 or the tilt drive unit 108 reaches a predetermined stipulated speed (resonance speed) does not exceed a predetermined time period. The acceleration indicates the variation of the driving speed per unit time.

The imaging apparatus 100 according to the present exemplary embodiment holds resonance information. Generally, drive sources such as motors for driving the pan drive unit 106 and the tilt drive unit 108 may cause a resonance with the imaging apparatus body depending on a particular driving frequency, possibly generating noise or vibration. More specifically, a resonance may occur if the pan drive unit 106 or the tilt drive unit 108 is driven at the speed corresponding to a particular driving frequency that generates a structural resonance. To prevent or reduce such a resonance, the imaging apparatus 100 holds information about the speed at which a resonance occurs. A specific method for resonance reduction will be described below.

### <Descriptions of Apparatuses>

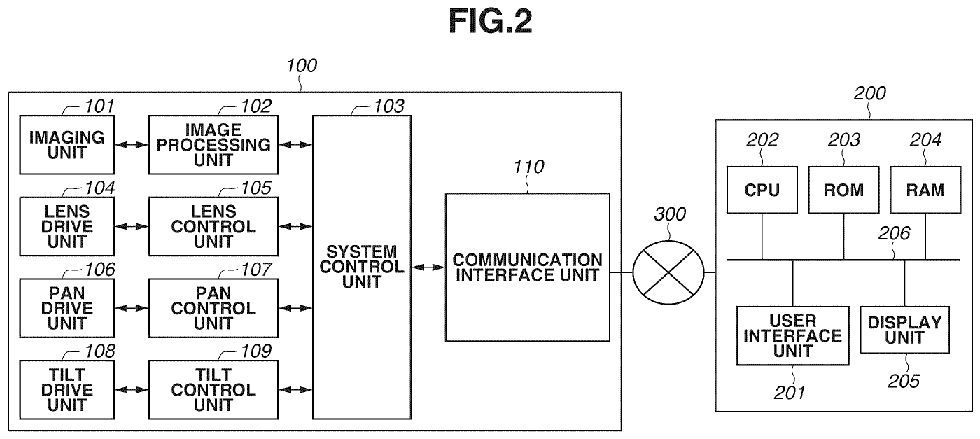

Examples of functional configurations of the imaging apparatus 100 and the external apparatus 200 according to the present exemplary embodiment will be described below with reference to FIG. 2. The configurations illustrated in FIG. 2 are to be considered as example configurations for implementing the present exemplary embodiment, and are not limited to the example. The configurations in FIG. 2 merely indicate main configurations for implementing operations of the imaging apparatus 100 (described below). For example, illustrations are omitted for the configuration for a power supply system, the configuration for recording and distributing captured images, and other configurations not essential in the following descriptions. As a specific example, processing of at least some of components may be implemented by hardware incorporated in the imaging apparatus 100. Dedicated circuits such as an Application Specific Integrated Circuit (ASIC) and a Digital Signal Processor (DSP) are applicable to the relevant hardware.

As illustrated in FIG. 2, the imaging apparatus 100 includes an imaging unit 101, an image processing unit 102, a system control unit 103, a lens drive unit 104, a lens control unit 105, a pan drive unit 106, a pan control unit 107, a tilt drive unit 108, a tilt control unit 109, and a communication interface unit 110. Although, in the present exemplary embodiment, the imaging apparatus 100 and the external apparatus 200 have been described above as separate units, the present exemplary embodiment is not limited thereto. For example, the imaging apparatus 100 may include a user interface unit 201 (described below). In this case, a control command input via the user interface unit 201 is output to the system control unit 103.

The imaging unit 101 converts external light into an image signal through photoelectric conversion. The relevant image signal is output to the image processing unit 102 on the subsequent stage. Examples of image sensors usable for photoelectric conversion include a Complementary Metal Oxide Semiconductor (CMOS) image sensor and a Charge Coupled Device (CCD) image sensor.

The image processing unit 102 is a circuit for generating a captured image by subjecting the image signal output from the imaging unit 101 to various known image processing. For example, the image processing unit 102 digitizes the image signal acquired from the imaging unit 101 and converts the image signal into captured image data reproducible by other apparatuses. To allow the image processing unit 102 to convert an image signal into image data, image data in various known formats such as High Efficiency Video Coding (HEVC) can be applied. The image processing unit 102 may suitably subject the relevant captured image to compressing and encoding processing. Examples of image processing applied to a digital image signal by the image processing unit 102 include offset processing, gamma correction processing, gain processing, Red, Green, Blue (RGB) interpolation processing, noise reduction processing, and color correction processing.

The system control unit 103 includes a processor (such as a Central Processing Unit (CPU) and a Digital Signal Processor (DSP)) and a memory (such as a Random Access Memory (RAM)). When the relevant processor executes processing by using a computer program and data stored in the relevant memory, the system control unit 103 performs the operation control of each unit included in the imaging apparatus 100. As a result, the system control unit 103 executes or controls each piece of processing (described below) to be performed by the imaging apparatus 100. For example, the system control unit 103 instructs the image processing unit 102 to perform image quality adjustment, and instructs the lens control unit 105 to perform zoom and focus control. The system control unit 103 instructs the pan control unit 107 and the tilt control unit 109 to perform a pan operation and a tilt operation, respectively.

According to the present exemplary embodiment, the system control unit 103 acquires the target speed set by the user on the external apparatus 200, via the communication interface unit 110. In this case, the system control unit 103 calculates the acceleration based on the target speed and predetermined information. A specific method for calculating the acceleration will be described below.

According to the present exemplary embodiment, the target speed refers to a speed setting received from the user via the user interface unit 201. The system control unit 103 acquires the driving speeds of the pan drive unit 106 and the tilt drive unit 108, and controls the pan drive unit 106 and the tilt drive unit 108 to be accelerated (decelerated) until their driving speeds reach the target speeds. According to the present exemplary embodiment, the driving speed is calculated based on a control interval, and the pan position of the pan drive unit 106 and the tilt position of the tilt drive unit 108 acquired by encoders in the pan drive unit 106 and the tilt drive unit 108, respectively, (described below).

Although, in the present exemplary embodiment, the target speed is set by the user, the target speed is not limited to the example.

For example, if the user can set a desired speed value based on the upper and lower limits of the driving speed of the imaging apparatus 100 as target parameters, the imaging apparatus 100 calculates the target speed based on the target speed parameter set by the user. If the user can select the target speed from two different speeds (low and high speeds), the system control unit 103 acquires the parameter of the target speed selected by the user, as a target speed parameter, via the communication interface unit 111.

The system control unit 103 calculates the target speed based on the target speed parameter.

The lens drive unit 104 includes focusing lens and zoom lens driving systems and motors as their drive sources. For example, the lens drive unit 104 includes a lens mechanism for performing optical zooming and actuators such as stepping motors. The operation control of the lens drive unit 104 is performed by the lens control unit 105.

The lens control unit 105 connected with the system control unit 103 performs the operation control of the lens drive unit 104 based on an instruction from the system control unit 103.

The pan drive unit 106 includes a mechanical drive system and a motor as a drive source for performing the pan operation of the imaging apparatus 100. For example, the pan drive unit 106 can rotate the imaging direction (the optical axis of the imaging lens) by 360 degrees in the pan direction. The pan drive unit 106 includes a mechanism for performing the pan operation, an actuator such as a stepping motor, and an encoder for detecting the pan position. The operation control of the pan drive unit 106 is performed by the pan control unit 107. The present exemplary embodiment will be described below on the premise that the pan drive unit 106 can rotate the imaging direction by 360 degrees in the pan direction. However, the rotatable angle in the pan direction is not limited to 360 degrees. For example, the imaging direction may be endlessly rotated.

The pan control unit 107 is connected with the system control unit 103 to perform the operation control of the pan drive unit 106 according to an instruction from the system control unit 103. The pan control unit 107 acquires information about the drive position of the pan drive unit 106 from the pan drive unit 106 and outputs the information to the system control unit 103.

The tilt drive unit 108 includes a mechanical drive system and a motor as a drive source for performing the tilt operation of the imaging apparatus 100. For example, the tilt drive unit 108 can rotate the imaging direction (the optical axis of the imaging lens) by 180 degrees in the tilt direction perpendicular to the pan direction. The tilt drive unit 108 includes a mechanism unit for performing the tilt operation, an actuator such as a stepping motor, and an encoder for detecting the tilt position. The operation control of the tilt drive unit 108 is performed by the tilt control unit 109. The present exemplary embodiment will be described below on the premise that the tilt drive unit 108 can rotate the imaging direction from −45 degrees anteriorly obliquely downward in the tilt direction to +90 degrees in the upward direction assuming the horizontal direction as 0 degrees. However, the rotatable angle in the tilt direction is not limited to the example. For example, the imaging direction may be endlessly rotated.

The tilt control unit 109 is connected with the system control unit 103 to perform the operation control of the tilt drive unit 108 according to an instruction from the system control unit 103. The tilt control unit 109 acquires information about the drive position of the tilt drive unit 108 from the tilt drive unit 108 and outputs the information to the system control unit 103.

The communication interface unit 110 performs data communication with the external apparatus 200. For example, the communication interface unit 110 transmits a captured image generated by the image processing unit 102 to an external apparatus, and receives setting data including pan and tilt operation settings, such as the target speeds of the pan drive unit 106 and the tilt drive unit 108, transmitted from the external apparatus 200.

The external apparatus 200 includes the user interface unit 201, a CPU 202, a Read Only Memory (ROM) 203, a Random Access Memory (RAM) 204, a display unit 205, and an internal bus 206 enabling communication with each other.

The user interface unit 201 includes a mouse or keyboard for accepting an operation from the user and outputting an accepted result to the CPU 202. The user interface unit 201 receives an operation from the user, and the CPU 202 converts the instruction corresponding to the operation into a control command.

The CPU 202 controls each component of the external apparatus 200 to control the entire apparatus. The CPU 202 transmits a control command related to the imaging apparatus 100 to the imaging apparatus 100 via the network 300. The CPU 202 controls the entire external apparatus 200 based on a response related to the external apparatus 200 acquired from the imaging apparatus 100 via the network 300. For example, upon acquisition of a captured image from the imaging apparatus 100, the CPU 202 controls the display unit 205 to display the image.

The ROM 203 is used as a permanent storage area for storing an operating system (OS), various programs, and various data, and is also used as a short-term storage area for storing various data.

The RAM 204 is a high-speed volatile storage device represented by a Dynamic RAM (DRAM). The OS, various programs, and various data are loaded into the RAM 204 which is also used as a work area for the OS and various programs.

The display unit 205 is, for example, a Liquid Crystal Display (LCD) for displaying captured images and various settings acquired from the imaging apparatus 100. The display unit 205 displays captured images transmitted from the imaging apparatus 100, screens for making settings necessary for the pan and tilt control, and buttons for performing the pan and tilt control.

### <Descriptions of Basic Control in Pan Direction Control>

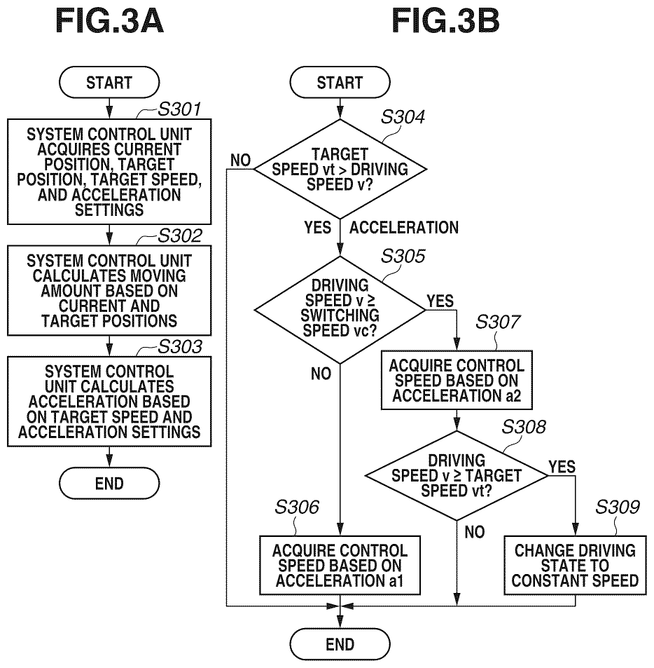

FIG. 3A is a flowchart illustrating acceleration calculation processing in pan control processing of the imaging apparatus 100 according to the present exemplary embodiment. This flowchart is executed by the system control unit 103. Processing of this flowchart is implemented when the OS, various programs, and various data are loaded into the RAM 204 (a storage device for temporarily storing the computer program to be executed by the system control unit 103) and then executed by the system control unit 103. The system control unit 103 executes the flowchart in FIG. 3A when it receives a control command from the external apparatus 200 via the communication interface unit 110 and calculates the acceleration based on the control command. The present exemplary embodiment will be described below centering on the acceleration calculation processing in pan direction speed control for the sake of simplification. The acceleration calculation processing in tilt direction speed control is performed in a similar way.

In step S301, the system control unit 103 acquires the current position of the pan drive unit 106 from the pan control unit 105, and acquires the target position and the target speed vₜ of the pan drive unit 106, total acceleration time, acceleration time ratio K, and acceleration ratio k from the external apparatus 200. The total acceleration time T, the acceleration time ratio K, and the acceleration ratio k are also collectively referred to as acceleration settings for the sake of simplification. The target position refers to the position of the pan drive unit 106 in the pan, tilt, and zoom positions set by a control command. The target speed vₜ indicates the speed set by the user via the user interface unit 201. The total acceleration time T indicates the time period during which the drive unit accelerates until its driving speed reaches the target speed vₜ. The acceleration time ratio K indicates the ratio of the time period during which the drive unit accelerates with a predetermined acceleration to the total acceleration time T. The switching speed v_{c} is a threshold value at which the acceleration is changed (described in detail below). As described below, the system control unit 103 calculates the acceleration with which the current speed v (driving speed) of the pan drive unit 106 reaches the target speed vₜ.

In step S302, the system control unit 103 calculates the moving amount in the pan direction based on the target and the current positions. For example, when the current position is 10 degrees, and the target position is 150 degrees, the system control unit 103 calculates the moving amount as 150-10=140 degrees.

In step S303, the system control unit 103 calculates the acceleration based on the target speed vₜ and the acceleration settings. Although, in the present exemplary embodiment, the target speed vₜ and the acceleration settings set by the external apparatus 200 are acquired by the system control unit 103 via the communication interface unit 110, the target speed vₜ and the acceleration settings are not limited to the example. The target speed vₜ and the acceleration settings may be information held by the system control unit 103. These pieces of information may be automatically determined upon acquisition of at least one piece of information from the external apparatus 200. According to the present exemplary embodiment, the pan drive unit 106 is controlled based on two different accelerations: an acceleration a₁ and an acceleration a₂. If the drive unit is controlled with multiple accelerations, the time period during which the drive unit accelerates with each acceleration can be calculated based on the total acceleration time T and the acceleration time ratio K.

A case where the drive unit is controlled based on two different accelerations, a first and a second acceleration, will be described below. When the total acceleration time T is 5 seconds, and the acceleration time ratio K is 0.2, the system control unit 103 calculates a first acceleration time period during which the drive unit accelerates with the first acceleration (acceleration a₁) as 5*0.2=1, and a second acceleration time period during which the drive unit accelerates with the second acceleration (acceleration a₂) as 5*(1−0.2)=4.

The system control unit 103 calculates the switching speed v_{c} based on the target speed vₜ and the acceleration ratio k.

The switching speed v_{c} is a threshold value for changing the acceleration. When the driving speed v exceeds the switching speed v_{c} (v>v_{c}), i.e., when the driving speed v reaches the switching speed v_{c}, the system control unit 103 changes the acceleration to be used to control the drive unit.

A relation between the switching speed v_{c} as the acceleration switching speed and the target speed vₜ is represented by the following formula using the acceleration ratio k:

$${v}_{c} = k * {v}_{t}$$

For example, when the acceleration ratio k is 0.1 and the target speed vₜ is 10 degrees/s (s denotes seconds), the system control unit 103 calculates the switching speed v_{c} as 0.1*10=1 degree/s.

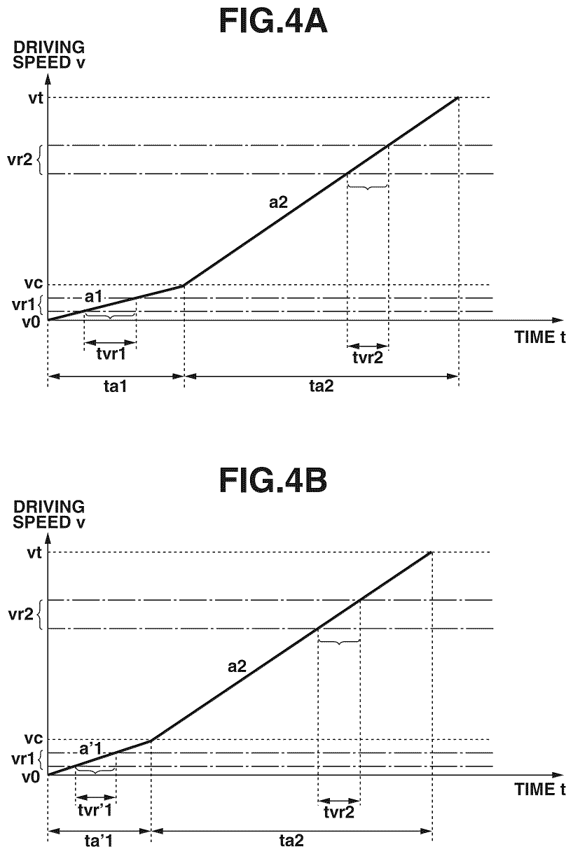

FIGS. 4A and 4B illustrate acceleration operations of the pan drive unit 106 of the imaging apparatus 100 according to the present exemplary embodiment. As described above, the present exemplary embodiment subjects the pan drive unit 106 to the linear acceleration control with two different acceleration inclinations. FIGS. 4A and 4B illustrate a first acceleration time period tₐ₁, a second acceleration time period tₐ₂, the switching speed v_{c}, the target speed vₜ, the acceleration a₁, and the acceleration a₂.

According to the present exemplary embodiment, the speed is represented by (rotational angle in the pan direction/number of seconds).

The system control unit 103 calculates the acceleration based on the acceleration ratio k, the total acceleration time T, and the acceleration time ratio K to enable smooth acceleration up to the target speed vₜ.

The acceleration a₁ is calculated by Formula (1) using the switching speed v_{c} and the acceleration time period tₐ₁.

$${a}_{1} = \frac{{v}_{c}}{{t}_{a 1}} \qquad ( 1 )$$

The acceleration a₂ is calculated by Formula (2) using the target speed vₜ, the switching speed v_{c}, and the acceleration time period tₐ₂.

$${a}_{2} = \frac{{v}_{t} - {v}_{c}}{{t}_{a 2}} \qquad ( 2 )$$

The deceleration calculation is similar to the acceleration calculation. The system control unit 103 calculates and sets the accelerations as described above and then ends this control.

The present exemplary embodiment has been described above centering on an example of the linear acceleration control with two different acceleration inclinations. However, the present exemplary embodiment is not limited to the example. Examples of applicable control include the linear acceleration control with one acceleration inclination and the S-shaped curve acceleration control in which the acceleration is gently started, gradually changed, and then gently ended. In such control, the acceleration time ratio K and the acceleration ratio k are differentiated for each type of control.

FIG. 3B is a flowchart illustrating the pan driving speed control processing during the drive control of the imaging apparatus 100 according to the present exemplary embodiment. The pan driving speed control processing will be described below with reference to FIG. 3B. Processing of this flowchart is implemented when the OS, various programs, and various data are loaded into the RAM 204 (a storage device for temporarily storing the computer program to be executed by the system control unit 103) and then executed by the system control unit 103. After starting the pan direction speed control, the system control unit 103 executes the flowchart in FIG. 3B at predetermined control intervals. Executing the speed control at predetermined intervals as in the flowchart in FIG. 3B enables performing the drive control while correcting an error. The present exemplary embodiment performs the relevant control based on the acceleration calculated according to the flowchart in FIG. 3A. The following descriptions will be made on the premise that the accelerations a₁ and a₂ have been calculated according to the flowchart in FIG. 3A.

In step S304, the system control unit 103 determines whether the driving speed v of the pan drive unit 106 is lower than the target speed vₜ. In this case, the system control unit 103 may determine information about the driving state of the pan drive unit 106. According to the difference between the target speed vₜ and the driving speed v of the pan drive unit 106, the system control unit 103 determines whether the current state of the pan drive is acceleration, constant speed, or deceleration. A method for determining each state is illustrated in Table 1.

TABLE 1

| Difference | vₜ > v | vₜ = v | vₜ < v |
|---|---|---|---|
| Determination | Acceleration | Constant speed | Deceleration |

When the system control unit 103 determines that the driving speed v is lower than the target speed vₜ or that the driving state of the pan drive unit 106 is acceleration (YES in step S304), the processing proceeds to step S305. When the system control unit 103 determines that the driving speed v is not lower than the target speed vₜ or that the driving state of the pan drive unit 106 is not acceleration (NO in step S304), the processing exits this flowchart.

In step S305, the system control unit 103 determines whether the driving speed v of the pan drive unit 106 has reached the switching speed v_{c}. When the system control unit 103 determines that the driving speed v has not reached the switching speed v_{c} (NO in step S305), the processing proceeds to step S306. When the system control unit 103 determines that the driving speed v has reached the switching speed v_{c} (YES in step S305), the processing proceeds to step S307.

In step S306, the system control unit 103 calculates the control target speed (control speed) based on the acceleration a₁ of the pan drive unit 106. For example, when the driving speed v is 0.1 degrees/s, the acceleration a₁ is 0.5 degrees/s², and the control interval is 1 millisecond, the system control unit 103 calculates the control speed as 0.1+0.5*0.001=0.1005 degrees/s, and outputs a control command to the pan control unit 107 to achieve the relevant speed of the pan drive unit 106. Subsequently, the system control unit 103 gradually increases the control speed depending on the predetermined control interval to implement the acceleration operation.

In step S307, the system control unit 103 calculates the control speed based on the acceleration a₂ of the pan drive unit 106. For example, when the driving speed v is 1 degree/s, the acceleration a₂ is 1.8 degrees/s², and the control interval is 1 millisecond, the system control unit 103 calculates the next control speed as 1+1.8*0.001=1.0018 degrees/s, and outputs a control command to the pan control unit 107 to achieve the relevant speed of the pan drive unit 106. Subsequently, the system control unit 103 gradually increases the control speed depending on the predetermined control interval to implement the acceleration operation.

Although, in the present exemplary embodiment, the system control unit 103 calculates the next control speed based on the driving speed, the present exemplary embodiment is not limited to the example. In an example case for calculating the control speed at 1 millisecond control intervals, the system control unit 103 may calculate the control speed at n seconds based on the control speed calculated at n−1 milliseconds assuming that the drive is started at 0 seconds. More specifically, the system control unit 103 may calculate the control speed based on the driving speed calculated by using the positional information for each drive unit or calculate the control speed to be output as the next control command, based on the calculated control speed.

In step S308, the system control unit 103 acquires the driving speed v of the pan drive unit 106 and determines whether the acquired driving speed v has reached the target speed vₜ. When the driving speed v has not reached the target speed vₜ (NO in step S308), the system control unit 103 continues the acceleration state. Then, the processing exits this flowchart. When the driving speed v has reached the target speed vₜ (YES in step S308), the processing proceeds to step S309.

In step S309, the system control unit 103 controls the pan drive unit 106 to change the driving state from acceleration to constant speed. Then, the processing exits this flowchart.

For the tilt control of the imaging apparatus 100, the system control unit 103 performs similar processing to the pan control.

### <Descriptions of Acceleration Calculation Processing in Consideration of Resonance>

If the system control unit 103 performs the control processing for the pan drive unit 106 based on the set accelerations as illustrated in FIGS. 3A and 3B, a resonance may occur during the acceleration (deceleration). If such a resonance keeps occurring for a predetermined time period or longer, the quietness and smooth PT control demanded for an imaging apparatus used for video production cannot be implemented.

In the pan drive control while changing the driving speed, according to the present exemplary embodiment, acceleration determination processing is performed so that the time period during which the driving speed corresponds to the resonance speed (at which a resonance occurs) does not exceed a predetermined time period.

More specifically, in calculating the acceleration in FIG. 3A, the system control unit 103 determines the accelerations based on information about a resonance speed range (resonance range). More specifically, in the drive control with the acceleration calculated based on the target speed vₜ and the acceleration settings, if the time period during which the driving speed corresponds to the resonance speed is longer than a predetermined time period (stipulated time period t), according to the present exemplary embodiment, the time period of the acceleration is changed so that the relevant time period does not exceed the stipulated time period t. If the relevant time period is equal to or shorter than the predetermined time, according to the present exemplary embodiment, the drive control is performed based on the accelerations calculated based on the target speed vₜ, the total acceleration time T, the acceleration time ratio K, and the acceleration ratio k.

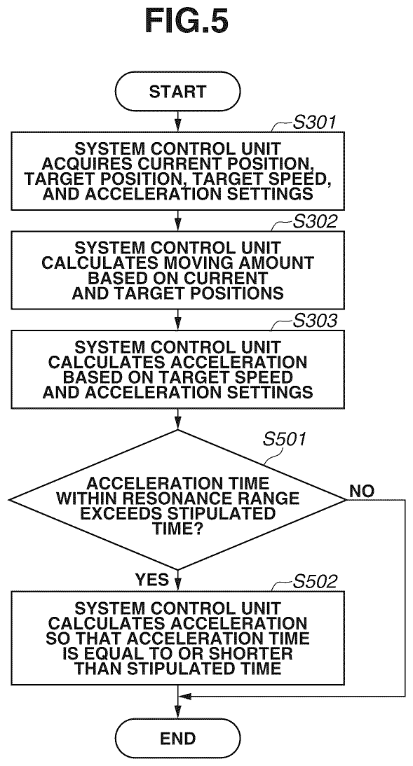

FIG. 5 is a flowchart illustrating the pan direction speed control processing for the imaging apparatus 100 in consideration of the resonance range setting according to the present exemplary embodiment. The flowchart in FIG. 5 is executed when the system control unit 103 receives a control command from the external apparatus 200 via the communication interface unit 110, and calculates the accelerations based on the control command. The present exemplary embodiment will be described below centering on the acceleration calculation processing in the pan direction speed control for the sake of simplification. The acceleration calculation processing in the tilt direction speed control is performed in a similar way. According to the present exemplary embodiment, the speed at which a resonance occurs is set as the resonance speed and a range in which the resonance occurs is set as the resonance range, and the time period during which the driving speed is controlled within the resonance speed range is reduced, so that the influence of the resonance is prevented.

Steps S301 to S303 are the same as those in FIG. 3A, and redundant descriptions thereof will be omitted.

In step S501, the system control unit 103 acquires preset resonance information. Although, in the present exemplary embodiment, the system control unit 103 holds the relevant resonance information, the present exemplary embodiment is not limited to the example. For example, the system control unit 103 may acquire the relevant resonance information from the external apparatus 200. The resonance information also includes information about a stipulated speed range and information about the stipulated time period t. The stipulated speed range indicates the range of the driving speed of the imaging apparatus at which a resonance occurs (the range of viewing angle control speed at which a vibration and sound occur by resonance).

In step S501, the system control unit 103 determines whether the time period of the acceleration within the stipulated speed range (resonance range) is longer than the stipulated time period t at the time of acceleration with the acceleration set in step S303. When the system control unit 103 determines that the relevant time period is longer than the stipulated time period t (YES in step S501), the processing proceeds to step S502. When the system control unit 103 determines that the relevant time period does not exceed the stipulated time period t (NO in step S501), the processing exits this flowchart. Although, in the present exemplary embodiment, the stipulated time period t is described to be identical regardless of the predetermined speed range, the present exemplary embodiment is not limited to the example. The stipulated time period t may be differentiated for each predetermined speed range. For example, in a case of the low driving speed, the influence of a resonance occurring when a captured image vibrates even in a short time is more perceivable than the influence in a case of the high driving speed. Therefore, the stipulated time period t set with tₐᵣ₁ may be shorter than the stipulated time period t set with tₐᵣ₂.

A case where the accelerations a₁ and a₂ are set in step S303 will be described below with reference to FIG. 2A. At the time of acceleration with the acceleration a₁ for the acceleration time period tₐ₁, the time period during which the driving speed corresponds to a speed range of a resonance range vᵣ₁ is a time period tᵥᵣ₁. In step S501, the system control unit 103 determines whether the time period tᵥᵣ₁ is longer than the stipulated time period t.

In step S502, the system control unit 103 calculates the acceleration so that the time period of the acceleration within the stipulated speed range (resonance range) does not exceed the stipulated time period t. Then, the processing proceeds to step S304.

For example, the following describes a case, at the time of acceleration with the acceleration a₁, where the time period tᵥᵣ₁ during which the driving speed corresponds to a speed range of the resonance range vᵣ₁ is determined to exceed the stipulated time period t in step S303.

In step S304, the system control unit 103 sets an acceleration a′₁ so that the time period tᵥᵣ₁ becomes the stipulated time period t, as illustrated in FIG. 4B. Although, in this case, the system control unit 103 calculates the acceleration so that a time period t′ᵥᵣ₁ becomes the stipulated time period t, the present exemplary embodiment is not limited to the example. As long as the set time period t′ᵥᵣ₁ is equal to or shorter than the stipulated time period t, the system control unit 103 does not necessarily set the acceleration a′₁ in step S304.

In a case where multiple accelerations are used as illustrated in FIGS. 4A and 4B, i.e., if multiple accelerations are to be calculated, the system control unit 103 also applies the processing in steps S501 to S502 to the acceleration a₂. Then, the processing exits this flowchart. The pan control unit 107 or the tilt control unit 109 acquires the set accelerations from the system control unit 103, and controls the pan drive unit 106 or the tilt drive unit 108 to be driven with the acquired accelerations.

As described above, according to the present exemplary embodiment, the accelerations are calculated so that the time period of the acceleration within a predetermined speed range (the resonance range vᵣ₁) does not exceed the stipulated time period t, and thus, the time period of the acceleration within the resonance range is reduced and smooth camera operations are achieved without operator intervention.

The functions of the above-described exemplary embodiment can also be implemented by the following configuration. More specifically, a program code for implementing the processing of the present exemplary embodiment is supplied to a system or apparatus, and a computer (or CPU or micro processing unit (MPU)) of the system or apparatus executes the program code. In this case, the program code itself read from a storage medium will implement the above-described functions of the present exemplary embodiment, and the storage medium storing the program code will also implement the functions of the present exemplary embodiment.

The program code for implementing the functions of the present exemplary embodiment may be executed by either one computer (CPU or MPU) or a plurality of computers in a collaborative way. The program code may be executed by a computer, or hardware such as a circuit for implementing the functions of the program code may be provided. Alternatively, a part of the program code may be implemented by hardware, and the remaining portion may be executed by a computer.

A second exemplary embodiment will be described below. According to the first exemplary embodiment, the accelerations are calculated so that the pan drive unit 106 and the tilt drive unit 108 smoothly start and stop moving, and the time period of the acceleration within the predetermined speed range (resonance range) does not exceed a predetermined time period. If multiple accelerations are calculated (for example, the first acceleration (a₁) the second acceleration (a₂)), the system control unit 103 separately reviews each acceleration. For this reason, the ratio of the control time period of the two accelerations may not become the acceleration time ratio K. If the relevant ratio does not become the acceleration time ratio K, the pan drive unit 106 and the tilt drive unit 108 may not smoothly start and stop moving. Accordingly, in the present exemplary embodiment, the accelerations are calculated in consideration of the prevention of the influence of a resonance and the acceleration time ratio K.

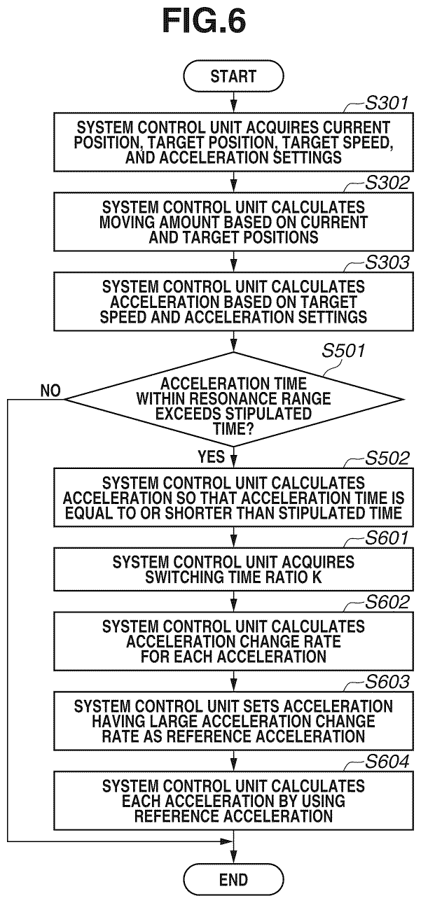

The acceleration calculation processing at the time of acceleration of the imaging apparatus 100 according to the present exemplary embodiment will be described below with reference to the flowchart in FIG. 6. FIG. 6 is a flowchart illustrating the acceleration calculation processing in consideration of the calculation about the resonance range and the acceleration time ratio K in the pan direction speed control processing for the imaging apparatus 100 according to the present exemplary embodiment. The flowchart in FIG. 6 is executed when the system control unit 103 receives a control command from the external apparatus 200 via the communication interface unit 110, and starts the pan control for up to a predetermined position based on the control command. Only differences from the flowcharts in FIGS. 3A, 3B, and 5 will be described below.

Steps S301 to S303 and steps S501 to S502 are similar to those in the first exemplary embodiment, and redundant descriptions thereof will be omitted.

In step S601, the system control unit 103 acquires the acceleration time ratio K. After the system control unit 103 acquires the acceleration time ratio K, the processing proceeds to step S602.

In step S602, the system control unit 103 calculates the acceleration change rate based on the acceleration calculated in step S303 and the acceleration calculated in step S502. The acceleration change rate is acquired as described below by using an acceleration a calculated based on the total acceleration time T, the acceleration time ratio K, and the acceleration ratio k, and an acceleration a′ calculated based on the stipulated speed range.

$$\frac{{a}^{′} - a}{a} \qquad ( 3 )$$

The system control unit 103 calculates the acceleration change rate by using the above-described formula. Then, the processing proceeds to step S603.

In step S603, for the acceleration having a large acceleration change rate, the system control unit 103 sets the acceleration a′ calculated in step S502, as the reference acceleration. An example case where the accelerations a′₁ and a′₂ are set in step S502 will be described below. When the system control unit 103 determines that the acceleration change rate of the acceleration a′₁ calculated in step S602 is larger than that of the acceleration a′₂, the system control unit 103 sets the acceleration a′₁ as the reference acceleration in step S603.

In step S604, the system control unit 103 calculates the accelerations based on the reference acceleration a′ and the acceleration time ratio K. An example case where the acceleration a′₁ is set as the reference acceleration will be described below. In this case, the acceleration a′₂ is acquired by using the acceleration a′₁ and the acceleration time ratio K as follows.

a′₂=Ka′₁

After the system control unit 103 sets the acceleration a′₂, the processing proceeds to step S304.

Although the present exemplary embodiment has been described above centering on a case where the pan direction speed control processing is performed based on two different accelerations, more than two accelerations may be used for the relevant control. In this case, the system control unit 103 calculates the continuous two accelerations, i.e., two accelerations having the same switching speed v_{c}, based on the control flow, and repeats this control flow until the calculation is completed for all accelerations. Likewise, even if the pan direction speed control processing is performed with three or more different accelerations within the stipulated speed range, the system control unit 103 calculates the two accelerations having the same switching speed v_{c} based on this control flow. However, the present exemplary embodiment is not limited to the example. For example, the system control unit 103 may calculates the accelerations in ascending order of the switching speed v_{c}. Although the present exemplary embodiment has been described above on the premise that the switching speed v_{c} remains unchanged, the present exemplary embodiment is not limited to the example. For example, the present exemplary embodiment may be implemented by fixing the acceleration time periods tai and tₐ₂ and changing the switching speed v_{c}.

As described above, the system control unit 103 calculates the accelerations so that the pan drive unit 106 and the tilt drive unit 108 smoothly start and stop moving. If the time period of the acceleration within the predetermined speed range (resonance range) exceeds the stipulated time period t, the system control unit 103 calculates the accelerations so that the relevant time period becomes the stipulated time period t. The system control unit 103 calculates the accelerations so that the ratio of the time period of movement with each acceleration remains unchanged, thus implementing operations for smoothly starting and stopping moving and shortening the time period of the acceleration within the resonance range.

A third exemplary embodiment will be described below. According to the first and the second exemplary embodiments, the pan and tilt accelerations are calculated in separate processing. In this case, if multiple accelerations (for example, the first acceleration (a₁) and the second acceleration (a₂)) are used, the timing when the acceleration changes is different between the pan and tilt operations. If the pan and tilt movements are made at the same time, the difference in the feeling of acceleration may cause an unnatural feeling. According to the present exemplary embodiment, the acceleration is calculated so that the pan and tilt accelerations change at the same timing.

The present exemplary embodiment will be described below centering on a case where the first and the second exemplary embodiments are applied to the calculation of the accelerations at the time of the pan and tilt acceleration. A flowchart of the acceleration calculation processing at the time of the pan and tilt acceleration by the imaging apparatus 100 will be described below with reference to FIG. 6.

The system control unit 103 starts this control flow upon acquisition of the target speed vₜ from the user interface unit 201, and ends the control flow upon completion of the calculation of the pan and tilt accelerations so that the time period during which the pan drive unit 106 accelerates with the pan acceleration coincides with the time period during which the tilt drive unit 108 accelerates with the tilt acceleration. Referring to FIG. 6, the acceleration time period tₐ₁ with the acceleration a₁ in the acceleration control in FIG. 2A will be described below on the assumption that the pan acceleration time period tₐ₁ is Pan-tₐ₁ and that the tilt acceleration time period tₐ₁ is Tilt-tₐ₁.

Steps S301 and S303 are the same as those in the first exemplary embodiment, and redundant descriptions thereof will be omitted.

In step S801, the system control unit 103 compares the time period of movement Pan-tₐ₁ with the pan acceleration with the time period of movement Tilt-tₐ₁ with the tilt acceleration. If there is a difference between the time period of movement Pan-tₐ₁ with the pan acceleration and the time period of movement Tilt-tₐ₁ with the tilt acceleration (YES in step S801), the processing proceeds to step S802. If there is no difference between the time period of movement Pan-tₐ₁ with the pan acceleration and the time period of movement Tilt-tₐ₁ with the tilt acceleration (NO in step S801), the processing exits the flowchart.

If the time period of movement Pan-tₐ₁ with the first pan acceleration is longer than the time period of movement Tilt-tai with the first tilt acceleration (YES in step S802), the processing proceeds to step S803. If the time period of movement Pan-tₐ₁ with the first pan acceleration is shorter than the time period of movement Tilt-tai with the first tilt acceleration (NO in step S802), the processing proceeds to step S804.

In step S803, the system control unit 103 adjusts Pan-tₐ₁ with Tilt-tₐ₁, and calculates and sets the first pan acceleration. Then, the processing exits the flowchart.

In step S804, the system control unit 103 adjusts Tilt-tai with Pan-tₐ₁, and calculates and sets the first tilt acceleration. Then, the processing exits the flowchart.

As described above, if the time period of the acceleration within the predetermined speed range (resonance range) exceeds the stipulated time period t, the system control unit 103 calculates the pan and tilt accelerations so that the relevant time period does not exceed the stipulated time period t. In this case, the system control unit 103 calculates the pan and tilt accelerations so as to adjust the timing when the accelerations change, thus reducing the unnatural feeling caused by the difference when the acceleration changes.

The imaging apparatus 100 according to the present exemplary embodiment associates the positions of the pan drive unit 106 and the tilt drive unit 108, the position of the zoom lens driven by the lens drive unit 104, and the target speed vₜ with preset numbers, making it possible to register these positions as preset positions.

For example, the system control unit 103 may associate at least either one of the pan position, the tilt position, and the zoom position, and the target speed vₜ with preset numbers, and register these positions as preset positions.

The system control unit 103 may also register preset positions by using predetermined pan, tilt, and zoom values converted from the position of the zoom lens of the lens drive unit 104 and the positions of the pan drive unit 106 and the tilt drive unit 108. The system control unit 103 may also register preset values including image quality settings in addition to the pan, tilt, and zoom positions.

According to the present exemplary embodiment, the user may be able to call the preset positions associated with preset numbers registered by a predetermined command via the user interface unit 201. When the user calls preset positions via the user interface unit 201, the imaging apparatus 100 controls the pan, the tilt, and the lens drive units based on information about the relevant preset positions stored in the system control unit 103. By registering different preset positions to the multiple preset numbers and specifying the order of the preset numbers, the system control unit 103 can move between the preset positions in specified order (preset switching). The preset switching according to the present exemplary embodiment indicates a loop operation for automatically switching between the multiple preset positions in specified order. The preset switching is implemented when the system control unit 103 moves the imaging apparatus 100 from a preset position to the next one through the acceleration, constant speed, and deceleration.

As described above, according to the present exemplary embodiment, the system control unit 103 starts the acceleration calculation processing upon acquisition of a drive control command from the external apparatus 200. However, the present exemplary embodiment is not limited to the example. For example, the system control unit 103 may start the acceleration calculation processing upon acquisition of preset number information from the external apparatus 200. The system control unit 103 may also start the acceleration calculation processing upon acquisition of preset switching information.

The present disclosure can also be achieved when a program for implementing at least one of the functions according to the above-described exemplary embodiments is supplied to a system or apparatus via a network or storage medium, and at least one processor in the computer of the system or apparatus reads and executes the program. Further, the present disclosure can also be achieved by a circuit such as an Application Specific Integrated Circuit (ASIC) for implementing at least one function.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-033389, filed Mar. 5, 2024, which is hereby incorporated by reference herein in its entirety.

What is claimed is:

1. A control apparatus configured to control an imaging apparatus including a drive unit for changing an imaging direction, the control apparatus comprising:
a calculation unit configured to calculate a target speed set to drive the drive unit at a predetermined speed, and an acceleration of the driving speed of the drive unit;
a control unit configured to control the drive unit based on the target speed and the acceleration calculated by the calculation unit; and
a determination unit configured to determine whether a time period during which the drive unit driven at the driving speed accelerates within a range of a stipulated speed is longer than a preset stipulated time period, the stipulated speed being defined based on a structural resonance of the imaging apparatus,
wherein, in a case where the determination unit determines that the time period during which the drive unit driven at the driving speed accelerates within the range of the stipulated speed is longer than the stipulated time period, the calculation unit calculates the acceleration so that the time period during which the drive unit accelerates does not exceed the stipulated time period within the range of the stipulated speed.

2. The control apparatus according to claim 1, wherein, in a case where two or more different accelerations are provided, the calculation unit further calculates a switching speed at which the acceleration is changed.

3. The control apparatus according to claim 2, wherein, when the driving speed exceeds the switching speed while the control unit controls the drive unit to be driven with a first acceleration, the control unit controls the drive unit to be driven with a second acceleration.

4. The control apparatus according to claim 2, wherein the switching speed is calculated by the calculation unit based on the target speed and a preset speed ratio.

5. The control apparatus according to claim 1, wherein the control unit controls the drive unit to accelerate up to the target speed based on the acceleration calculated by the calculation unit.

6. The control apparatus according to claim 1, wherein, when the control unit controls the drive unit to accelerate up to the target speed based on a plurality of accelerations, a ratio of a first acceleration time period during which the drive unit accelerates with a first acceleration to a second acceleration time period during which the drive unit accelerates with a second acceleration is a preset value.

7. The control apparatus according to claim 1,
wherein the drive unit of the imaging apparatus includes a pan drive unit configured to be driven in a pan direction and a tilt drive unit configured to be driven in a tilt direction, and
wherein the control unit controls the drive unit so that a third acceleration time period during which the pan drive unit accelerates with a third acceleration is identical to a fourth acceleration time period during which the tilt drive unit accelerates with a fourth acceleration.

8. A method for controlling a control apparatus configured to control an imaging apparatus including a drive unit for changing an imaging direction, the method comprising:
calculating a target speed set to drive the drive unit at a predetermined speed, and an acceleration of the driving speed of the drive unit;
controlling the drive unit based on the target speed and the acceleration calculated in the calculating; and
determining whether a time period during which the drive unit driven at the driving speed accelerates within a range of a stipulated speed is longer than a preset stipulated time period, the stipulated speed being defined based on a structural resonance of the imaging apparatus,
wherein, in a case where the time period during which the drive unit driven at the driving speed accelerates within the range of the stipulated speed is determined to be longer than the stipulated time period, the acceleration is calculated so that the time period during which the drive unit accelerates does not exceed the stipulated time period within the range of the stipulated speed.

9. A non-transitory storage medium storing a computer program instruction for causing a computer execute a method for controlling a control apparatus configured to control an imaging apparatus including a drive unit for changing an imaging direction, the method comprising:
calculating a target speed set to drive the drive unit at a predetermined speed, and an acceleration of the driving speed of the drive unit;
controlling the drive unit based on the target speed and the acceleration calculated in the calculating; and
determining whether a time period during which the drive unit driven at the driving speed accelerates within a range of a stipulated speed is longer than a preset stipulated time period, the stipulated speed being defined based on a structural resonance of the imaging apparatus,
wherein, in a case where the time period during which the drive unit driven at the driving speed accelerates within the range of the stipulated speed is determined to be longer than the stipulated time period, the acceleration is calculated so that the time period during which the drive unit accelerates does not exceed the stipulated time period within the range of the stipulated speed.
